(19) United States
(12) Patent Application Publication
(10) Pub. No.: US 2005/0165504 A1
(43) Pub. Date: Jul. 28, 2005

(54) Methods and apparatus for facilitating manufacturing

(76) Inventor: Michael H. Feige, Bridgenorth (CA)

Correspondence Address: JOHN S. BEULICK;C/O ARMSTRONG TEASDALE, LLP, ONE METROPOLITAN SQUARE, SUITE 2600, ST LOUIS, MO, 63102-2740, US

(21) Appl. No.: 10/762,418

(22) Filed: Jan. 22, 2004

(51) Int. Cl. G06F 19/00

(52) U.S. Cl. 700/97

(57) ABSTRACT

A method for facilitating manufacturing includes generating a computer model of an object using a design program, automatically extracting at least a portion of the computer model from the design program and automatically inputting the extracted portion into a planning program, and fabricating the object using the planning program.

### BACKGROUND OF THE INVENTION

This invention relates generally to computer modeling and designing, and, more particularly, to manufacturing an object using a computer model.

In manufacturing, an initial design phase includes designing a part, then choosing materials for the part and determining a process to make the part. Typically, as part of the design phase, the manufacturer will generate a computer model of the part utilizing computer modeling tools, such as, for example, Pro/ENGINEER commercially available from Parametric Technology Corporation, Waltham, Mass. The manufacturer will then extract a plurality of design parameters from the modeling tool, and manually enter the design parameters into a planning tool, such as, for example, Macola commercially available from Exact Software, Andover, Mass. The tooling used to fabricate the part is then selected based on the planning program.

Manually inputting design information into a planning tool facilitates an increase in a quantity of time to manufacture a part. Further, for complex parts, an increased amount of time may be used by the manufacturer to input the design into the planning program which may facilitate an increase in cost of the finished part.

### BRIEF DESCRIPTION OF THE INVENTION

In one aspect, a method for facilitating manufacturing is provided. The method includes generating a computer model of an object using a design program, automatically extracting at least a portion of the computer model from the design program and automatically inputting the extracted portion into a planning program, and fabricating the object using the planning program.

In another aspect, an apparatus for facilitating manufacturing is provided. The apparatus includes at least one manufacturing tool, and a computer coupled to the manufacturing tool and configured to generate a computer model of an object using a design program, automatically input at least a portion of the computer model into a planning program, and fabricate the object using the manufacturing tool based on the planning program.

In a further aspect, a computer for facilitating manufacturing is provided. The computer is configured to at least one of generate and receive a computer model of an object generated using a design program, and automatically input at least a portion of the computer model into a planning program.

### BRIEF DESCRIPTION OF THE DRAWINGS

FIG. 1 illustrates a method for facilitating manufacturing.

FIG. 2 is a process map of one embodiment of automatically inputting at least a portion of a computer model into a planning program.

FIG. 3 is a perspective view of a part manufactured according to the processes described herein.

FIG. 4 is a perspective view of the part illustrated in FIG. 3 with a single feature modified.

FIG. 5 is a perspective view of a subassembly manufactured according to the processes described herein.

FIG. 6 is a perspective view of the subassembly illustrated in FIG. 3 with a single feature modified.

FIG. 7 is process map for one embodiment of a method for generating computer models.

### DETAILED DESCRIPTION OF THE INVENTION

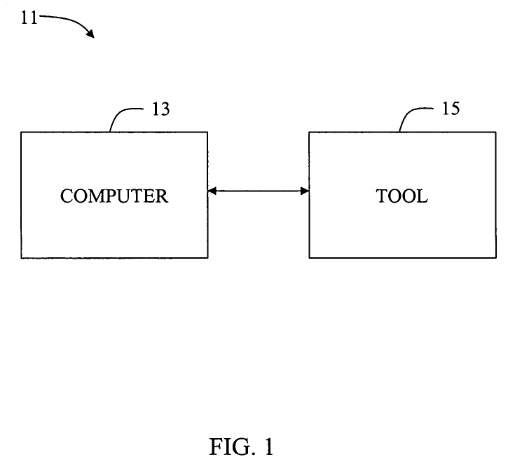

FIG. 1 is a method 10 for facilitating manufacturing, wherein method 10 includes generating 12 a computer model of an object using a design program installed on a computer, automatically 14 inputting at least a portion of the computer model into a planning program, and fabricating 16 the object using the planning program.

In an exemplary embodiment, the computer model is a solid model of a top-level assembly, i.e. a completed assembly, and is generated utilizing a computer modeling tool. In one embodiment, the top-level assembly includes at least one sub-assembly. In another embodiment, the top-level assembly is unitary and does not include any sub-assemblies. In another embodiment, the top-level assembly includes a plurality of parts capable of being assembled into a single top-level assembly. The solid model is a computer description of a closed, solid, three-dimensional shape which can be completely defined. Generating a solid model of a top-level assembly facilitates ensuring that all the spatial information is available for any subsequent analysis directly from the solid model itself. Further, a plurality of structural and material properties can be computed at any arbitrary point in the solid model or along any points of an arbitrarily directed ray at any time. Further, generating a solid model facilitates generating drawings or pictures of the modeled object, i.e. the top-level assembly, from any viewpoint.

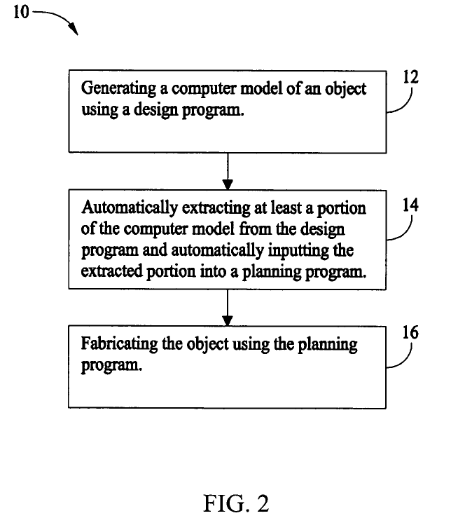

FIG. 2 is a process map of one embodiment of automatically 14 inputting at least a portion of the computer model into an automatic planning program. An automatic planning program, as used herein, refers to a program configured to automatically capture the solid model information from a program used to generate the solid model, and automatically output a plurality of operational steps to fabricate the top-level assembly.

In use, all operations to fabricate the top-level assembly are captured from the program used to generate the solid model information. In the exemplary embodiment, the automatic planning program captures or extracts a plurality of solid model information from the computer modeling program and uses the extracted data to generate a planning program to fabricate a physical structure, i.e. the top-level assembly. The operations generated by the planning program include all operations or steps to fabricate the top-level assembly including any subassemblies or parts included in the top-level assembly. In an exemplary embodiment, the automatic planning program generates a list of steps in sequential order, i.e. the order in which the top-level assembly, the subassemblies, or at least one part, is fabricated from a first step to a last step.

Once the list of steps is generated for the top-level assembly, the planning program is activated such that the selected sub-assemblies or parts are fabricated. If a portion of the top-level assembly is not selected, the portion of the planning program associated with fabricating this subassembly or part is not turned on. In other words, the operator may desire to fabricate a top-level assembly that does not include a specific subassembly or part. The planning program is configured to recognize any subassembly or part that has not been selected, or any subassembly or part that has been modified, by the operator and automatically skip the steps to fabricate this subassembly or part during the fabrication process.

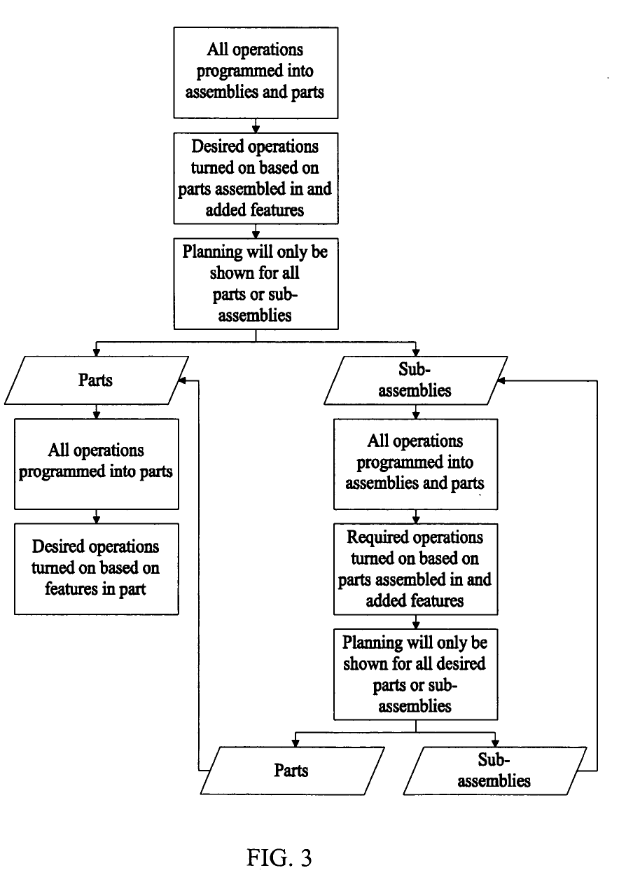

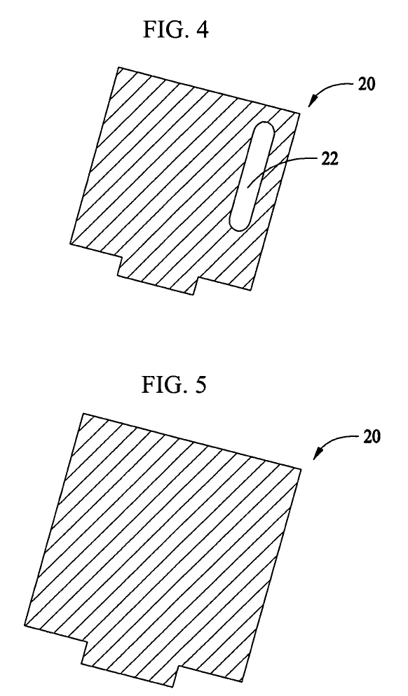

FIG. 3 is a perspective view of a part 20 manufactured according to the processes described herein. FIG. 4 is a perspective view of part 20 illustrated in FIG. 3 with a single feature 22 modified. In an exemplary embodiment, the planning program for part 20 shown in FIG. 3 includes:
OPERATION 010 FLAME CUT EXTERIOR TO DRAWING
OPERATION 020 FLAME CUT INTERIOR HOLE TO DRAWING
OPERATION 030 PREP FOR WELDING

If feature 22 (i.e. hole 22) is not desired, as shown in FIG. 4, the planning program is automatically modified, and the modified fabrication plan includes:
OPERATION 010 FLAME CUT EXTERIOR TO DRAWING
OPERATION 020 NOT REQUIRED
OPERATION 030 PREP FOR WELDING

As shown above, operation 020 has not been performed because hole 22 was not desired by the operator, therefore the planning program is automatically updated to skip this step.

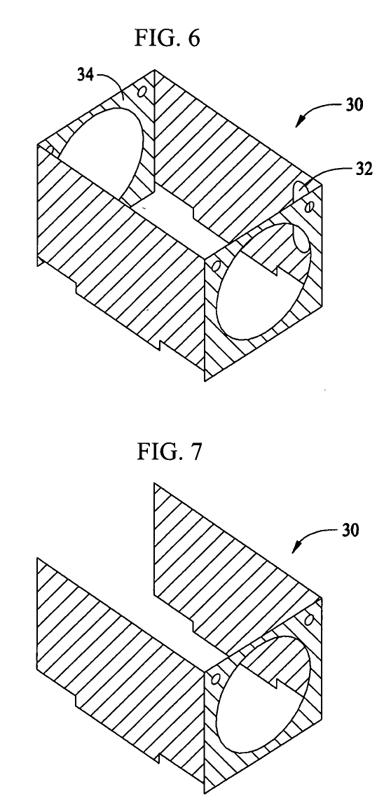

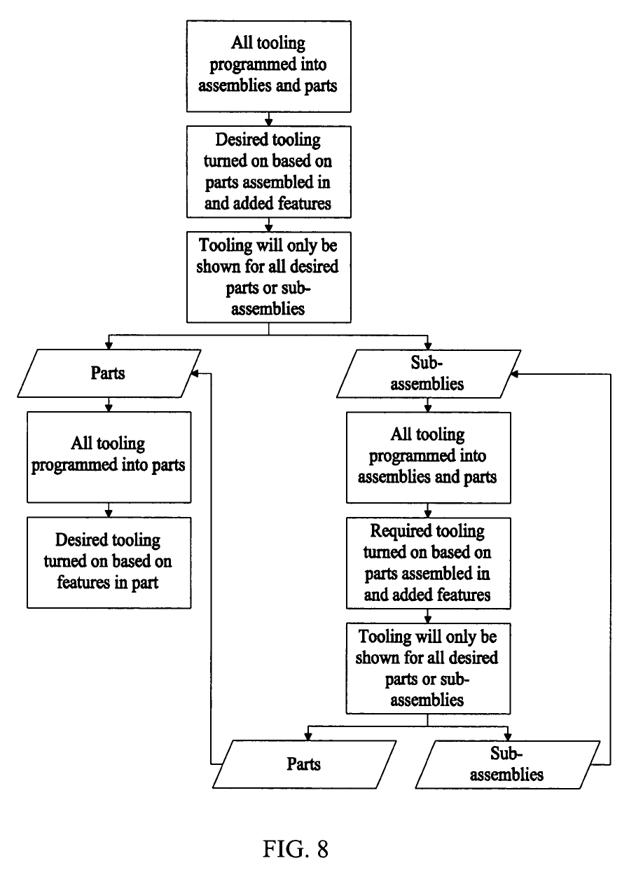

FIG. 5 is a perspective view of a subassembly 30 manufactured according to the processes described herein. FIG. 6 is a perspective view of subassembly 30 illustrated in FIG. 5 with a feature 32 modified. In an exemplary embodiment, fabrication planning for subassembly 30 shown in FIG. 5 includes:
TOP ASSEMBLY OPERATION 010 SET UP ON MILLING MACHINE
TOP ASSEMBLY OPERATION 020 BORE OUT AS PER DRAWING
TOP ASSEMBLY OPERATION 030 DRILL ALL HOLES AS REQUIRED
SUB ASSEMBLY OPERATION 010 CLEAN ALL PARTS
SUB ASSEMBLY OPERATION 020 WELD ALL SIDES AS PER DRAWING
SUB ASSEMBLY OPERATION 030 WELD BOTTOM PLATE AS PER DRAWING
PART ONE OPERATION 010 FLAME CUT TO DRAWING
PART ONE OPERATION 020 PREP FOR WELDING
PART FOUR OPERATION 010 FLAME CUT TO DRAWING
PART FOUR OPERATION 020 PREP FOR WELDING
PART TWO OPERATION 010 FLAME CUT TO DRAWING
PART TWO OPERATION 020 PREP FOR WELDING
PART THREE OPERATION 010 FLAME CUT EXTERIOR TO DRAWING
PART THREE OPERATION 020 FLAME CUT INTERIOR HOLE TO DRAWING
PART THREE OPERATION 030 PREP FOR WELDING

If feature 32 (i.e. hole 32) is not desired and a back plate 34 is not desired, as shown in FIG. 6, the planning program is automatically modified, and the modified planning program includes:
TOP ASSEMBLY OPERATION 010 SET UP ON MILLING MACHINE
TOP ASSEMBLY OPERATION 020 BORE OUT AS PER DRAWING
TOP ASSEMBLY OPERATION 030 DRILL ALL HOLES AS REQUIRED
SUB ASSEMBLY OPERATION 010 CLEAN ALL PARTS
SUB ASSEMBLY OPERATION 020 WELD ALL SIDES AS PER DRAWING
SUB ASSEMBLY OPERATION 030 WELD BOTTOM PLATE AS PER DRAWING
PART ONE OPERATION 010 FLAME CUT TO DRAWING
PART ONE OPERATION 020 PREP FOR WELDING
PART TWO OPERATION 010 FLAME CUT TO DRAWING
PART TWO OPERATION 020 PREP FOR WELDING
PART THREE OPERATION 010 FLAME CUT EXTERIOR TO DRAWING
PART THREE OPERATION 020 NOT REQUIRED
PART THREE OPERATION 030 PREP FOR WELDING

As shown above, hole 32 and back plate 34 were not desired by the operator, therefore the planning program is automatically modified to skip these steps.

Once the planning program is generated for the desired top-level assembly, the tooling information is generated to manufacture features that are included in the top-level assembly. In an exemplary embodiment, the presence or absence of the desired features will turn on or off the tooling used to fabricate these features. In another exemplary embodiment, the presence and/or absence of a certain assembly component may also turn on or off certain tooling. For example, the planning program generates a list of all the tooling used to fabricate the top-level assembly including all subassemblies and parts. If another data file is executed which changes the planning program, for example by adding or deleting subassemblies or parts from the top-level assembly, the tooling information for the top-level assembly will automatically update to reflect the desired changes.

FIG. 7 is a process map for one embodiment of automatically 14 inputting at least a portion of the computer model into a tooling program. Tooling program as used herein, refers to a program configured to capture the solid model information from the program used to generate the solid model, and output a list of tools used to fabricate the top-level assembly. In an exemplary embodiment, a computer including the planning program is coupled to at least one tool and is configured to receive information from the planning program and automatically select the tool based on the planning program. The planning program then directs the tool to perform a desired operation, e.g., cut, drill, punch, press, roll, bend, knurl, heat treat, anneal, anodize, polish, machine, etc.

In use, a tooling list to fabricate the top-level assembly is captured from the program used to generate the solid model information. The tooling list includes all tools used to fabricate the top-level assembly including any subassemblies or parts included in the top-level assembly. In one embodiment, the tooling list is extracted from the program used to generate the top-level assembly using the planning program. In another embodiment, the tooling list is not extracted using the planning program. In an exemplary embodiment, the tooling list is generated in sequential order, i.e. the order in which the top-level assembly, the subassemblies, or at least one part, is fabricated from a first tool used to a last tool used.

Once the tooling list is generated for the top-level assembly, the planning program is activated such that the selected sub-assemblies or parts are fabricated. If a portion of the top-level assembly is not selected, the portion of the tooling list associated with fabricating this subassembly or part is not turned on. In other words, the operator may desire to fabricate a top-level assembly that does not include a specific subassembly or part. The planning program is configured to recognize any subassembly or part that has not been selected, or any subassembly or part that has been modified, by the operator and automatically delete the tool used to fabricate this subassembly or part during the fabrication process.

In an exemplary embodiment, fabrication tooling for part 20 shown in FIG. 3 includes:
OPERATION 010 FLAME CUT EXTERIOR TO DRAWING
OPERATION 020 FLAME CUT INTERIOR HOLE TO DRAWING
OPERATION 020 TOOL NUMBER MS XXX 2.00 JNCI-I MILL
OPERATION 030 PREP FOR WELDING

If hole 22 (shown in FIG. 3) is not desired, as shown in FIG. 4, the fabrication tooling is automatically modified, and the modified fabrication plan includes:
OPERATION 010 FLAME CUT EXTERIOR TO DRAWING
OPERATION 020 NOT REQUIRED
OPERATION 030 PREP FOR WELDING

As shown above, operation 020 has not been performed because the hole was not desired by the operator, thereby automatically updating the program to skip this step and also delete the tool used to perform operation 020.

In an exemplary embodiment, fabrication tooling for subassembly 30 (shown in FIG. 5) includes:
TOP ASSEMBLY OPERATION 010 SET UP ON MILLING MACHINE
TOP ASSEMBLY OPERATION 020 BORE OUT AS PER DRAWING
TOP ASSEMBLY OPERATION 030 DRILL ALL HOLES AS REQUIRED
SUB ASSEMBLY OPERATION 010 CLEAN ALL PARTS
SUB ASSEMBLY OPERATION 020 WELD ALL SIDES AS PER DRAWING
SUB ASSEMBLY OPERATION 030 WELD BOTTOM PLATE AS PER DRAWING
PART ONE OPERATION 010 FLAME CUT TO DRAWING
PART ONE OPERATION 020 PREP FOR WELDING
PART FOUR OPERATION 010 FLAME CUT TO DRAWING
PART FOUR OPERATION 020 PREP FOR WELDING
PART TWO OPERATION 010 FLAME CUT TO DRAWING
PART TWO OPERATION 020 PREP FOR WELDING
PART THREE OPERATION 010 FLAME CUT EXTERIOR TO DRAWING
PART THREE OPERATION 020 FLAME CUT INTERIOR HOLE TO DRAWING
PART THREE OPERATION 020 TOOL NUMBER MS XXX 2.00 INCH MIL.L
PART THREE OPERATION 030 PREP FOR WELDING

If hole 32 and plate 34 are not desired, as shown in FIG. 6, the fabrication planning is automatically modified, and the modified fabrication plan includes:
TOP ASSEMBLY OPERATION 010 SET UP ON MILLING MACHINE
TOP ASSEMBLY OPERATION 020 BORE OUT AS PER DRAWING
TOP ASSEMBLY OPERATION 030 DRILL ALL I-IOLES AS REQUIRED
SUB ASSEMBLY OPERATION 010 CLEAN ALL PARTS
SUB ASSEMBLY OPERATION 020 WELD ALL SIDES AS PER DRAWING
SUB ASSEMBLY OPERATION 030 WELD BOTTOM PLATE AS PER DRAWING
PART ONE OPERATION 010 FLAME CUT TO DRAWING
PART ONE OPERATION 020 PREP FOR WELDING
PART TWO OPERATION 010 FLAME CUT TO DRAWING
PART TWO OPERATION 020 PREP FOR WELDING
PART THREE OPERATION 010 FLAME CUT EXTERIOR TO DRAWING
PART THREE OPERATION 020 NOT REQUIRED
PART THREE OPERATION 030 PREP FOR WELDING

As shown above, the tooling program has been modified by the operator to delete hole 32 and plate 34, thereby automatically updating the planning program to skip this step and remove the tool used to perform this step from the tooling list.

Automatically extracting model data from the modeling program facilitates reducing the time expended by the manufacturer to manufacture a part by eliminating the need to manually input design information into a planning tool. Accordingly, once the part is designed, the design information and tooling list can be extracted automatically facilitating a decrease in time to produce the part, and facilitating a decrease in time to make any desired modifications to the part, resulting in a decrease in cost to the manufacturer.

While the invention has been described in terms of various specific embodiments, those skilled in the art will recognize that the invention can be practiced with modification within the spirit and scope of the claims.

1. A method for facilitating manufacturing, said method comprising:
generating a computer model of an object using a design program;
automatically extracting at least a portion of the computer model from the design program and automatically inputting the extracted portion into a planning program configured to generate instructions for fabricating the object; and
fabricating the object using the planning program.

2. A method in accordance with claim 1 further comprising automatically selecting at least one tool based on the planning program.

3. A method in accordance with claim 1 wherein said automatically inputting at least a portion of the computer model into a planning program comprises automatically inputting at least a portion of the computer model into a planning program including a plurality of operations to fabricate the object.

4. A method in accordance with claim 1 wherein said automatically inputting at least a portion of the computer model into a planning program comprises automatically inputting at least a portion of the computer model into a planning program configured to recognize at least one of a subassembly and a part not selected by an operator and automatically update a list of operations to fabricate the object.

5. A method in accordance with claim 4 wherein said automatically updating the list of operations comprises automatically modifying a tooling list.

6. A method in accordance with claim 1 wherein said automatically inputting at least a portion of the computer model into a planning program comprises automatically inputting at least a portion of the computer model into a planning program including a tooling list.

7. A method for facilitating manufacturing, said method comprising:
generating a computer model of an object using a design program;
automatically inputting at least a portion of the computer model into a planning program configured to generate instructions for fabricating the object, said planning program configured to recognize at least one of a subassembly and a part not selected by an operator;
automatically update the planning program;
automatically selecting at least one tool based on the planning program; and
fabricating the object using the planning program.

8. Apparatus for facilitating manufacturing, said apparatus comprising:
at least one manufacturing tool; and
a computer coupled to said manufacturing tool and configured to:
generate a computer model of an object using a design program;
automatically input at least a portion of the computer model into a planning program configured to generate instructions applied to fabricate the object; and
fabricate the object using the manufacturing tool based on the planning program.

9. An apparatus in accordance with claim 8, wherein said computer further configured to automatically select at least one tool based on the planning program.

10. An apparatus in accordance with claim 8, wherein said computer further configured to automatically input at least a portion of the computer model into a planning program including a plurality of operations to fabricate the object.

11. An apparatus in accordance with claim 8, wherein said computer further configured to automatically input at least a portion of the computer model into a planning program configured to recognize at least one of a subassembly and a part not selected by an operator and automatically update a list of operations to fabricate the object.

12. An apparatus in accordance with claim 11, wherein said computer further configured to automatically modify a tooling list.

13. An apparatus in accordance with claim 8, wherein said computer further configured to automatically input at least a portion of the computer model into a planning program including a tooling list.

14. Apparatus for facilitating manufacturing, said apparatus comprising:
at least one manufacturing tool; and
a computer coupled to said at least one manufacturing tool and configured to:
at least one of generate a computer model of an object using a design program and receive a computer model of an object generated using a design program;
automatically input at least a portion of the computer model into a planning program configured to generate instructions applied to fabricate the object, said planning program configured to recognize at least one of a subassembly and a part not selected by an operator;
automatically update the planning program;
automatically select the at least one manufacturing tool based on the planning program; and
fabricate the object using the at least one manufacturing tool based on the planning program.

15. A computer for facilitating manufacturing, said computer configured to:
at least one of generate and receive a computer model of an object generated using a design program; and
automatically input at least a portion of the computer model into a planning program configured to generate instructions applied to fabricate the object.

16. A computer in accordance with claim 15, wherein said computer further configured to automatically select at least one tool based on the planning program.

17. A computer in accordance with claim 15, wherein said computer further configured to automatically input at least a portion of the computer model into a planning program including a plurality of operations to fabricate an object.

18. A computer in accordance with claim 15, wherein said computer further configured to automatically input at least a portion of the computer model into a planning program configured to recognize at least one of a subassembly and a part not selected by an operator and automatically update the planning program.

19. A computer in accordance with claim 18, wherein said computer further configured to automatically modify a tooling list.

20. A computer in accordance with claim 15, wherein said computer further configured to automatically input at least a portion of the computer model into a planning program including a tooling list.
